(19) United States
(12) Patent Application Publication
(10) Pub. No.: US 2025/0037323 A1
(43) Pub. Date: Jan. 30, 2025

(54) GENERATING ARTIFICIAL INTELLIGENCE (AI)-BASED IMAGES USING LARGE LANGUAGE MACHINE-LEARNED MODELS

(71) Applicant: Maplebear Inc., San Francisco, CA (US)

(72) Inventors: Prithvishankar Srinivasan, Seattle, WA (US); Shih-Ting Lin, Santa Clara, CA (US); Yuanzheng Zhu, Smyrna, GA (US); Min Xie, Santa Clara, CA (US); Shishir Kumar Prasad, Fremont, CA (US); Shrikar Archak, Newark, CA (US); Karuna Ahuja, San Francisco, CA (US)

(21) Appl. No.: 18/785,665

(22) Filed: Jul. 26, 2024

Related U.S. Application Data
(60) Provisional application No. 63/529,100, filed on Jul. 26, 2023.

(51) Int. Cl. G06T 11/00; G06T 5/70; G06V 10/764

(52) U.S. Cl. CPC G06T 11/00; G06T 5/70; G06V 10/764

(57) ABSTRACT

An online system performs a task in conjunction with the model serving system or the interface system. The system generates a first prompt for input to a machine-learned language model, which specifies contextual information and a first request to generate a theme. The system provides the first prompt to a model serving system for execution by the machine-learned language model, receives a first response, and generates a second prompt. The second prompt specifies the theme and a second request to generate a third prompt for input to an image generation model that includes a third request to generate one or more images of one or more items associated with the theme. The system receives the third prompt by executing the model on the second prompt, provides the third prompt to the image generation model, and receives one or more images for presentation.

### CROSS-REFERENCE TO RELATED APPLICATIONS

This application claims the benefit of U.S. Provisional Application No. 63/529,100, filed Jul. 26, 2023, which is incorporated by reference herein in its entirety.

### BACKGROUND

An online system is an online platform that provides one or more online services. An example of an online service is allowing users to perform transactions associated with items. The items may represent physical entities stored in a physical location, such as groceries. A user can place an order for purchasing items from participating retailers via the online system, with the shopping being done by a picker. After the personal shopper finishes shopping, the order is delivered to the user's address.

In some instances, online marketplaces and e-commerce sites engage in product recommendations and sponsored activities to promote sales and enhance customer experiences. Visual content, such as images and graphics, is essential for attracting customer attention and influencing purchasing decisions. However, creating high-quality and contextually relevant images for various events, occasions, and brands can be challenging and resource-intensive. Existing image generation solutions may lack the ability to produce images that capture the high fidelity of branded products, and the specific context of brand-agnostic recommendations.

### SUMMARY

In accordance with one or more aspects of the disclosure, the techniques described herein relate to a method for an online system performing a task in conjunction with a model serving system or an interface system. The online system generates a first prompt for input to a machine-learned language model, which specifies contextual information and a first request to generate a theme. The online system provides the first prompt to a model serving system for execution by the machine-learned language model, receives a first response, and generates a second prompt. The second prompt specifies the theme and a second request to generate a third prompt for input to an image generation model that includes a third request to generate one or more images of one or more items associated with the theme. The online system receives the third prompt by executing the machine-learned language model on the second prompt, provides the third prompt to the image generation model, and receives one or more images for presentation.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A shows an example of generated images by the image generation module using the generated prompt from the prompt generation module, in accordance with one or more embodiments.

FIG. 3B shows an example of finetuned images generated by the image tuning module, in accordance with one or more embodiments.

FIG. 4 is a flowchart for a method of generating images for product item advertisement, in accordance with some embodiments.

FIG. 5 is a flowchart illustrating an example method of generating images for product item advertisement, in accordance with some embodiments.

### DETAILED DESCRIPTION

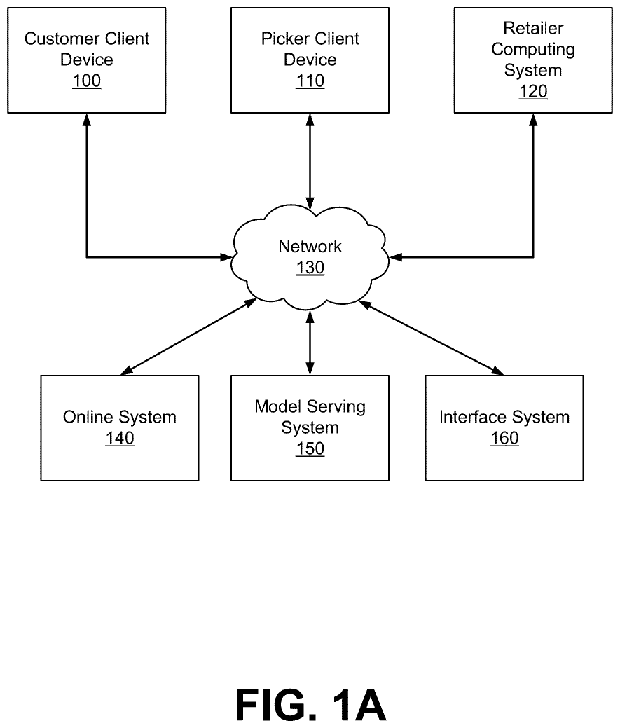

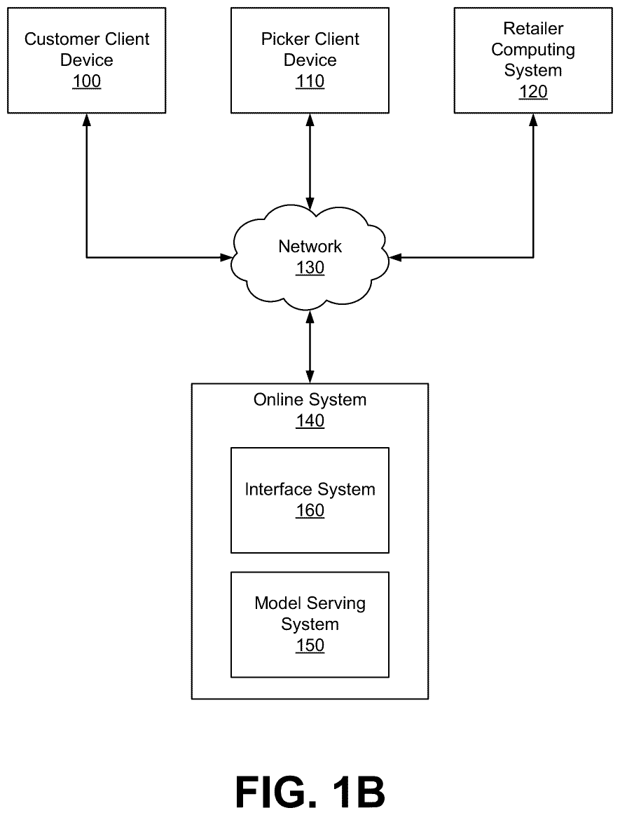

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

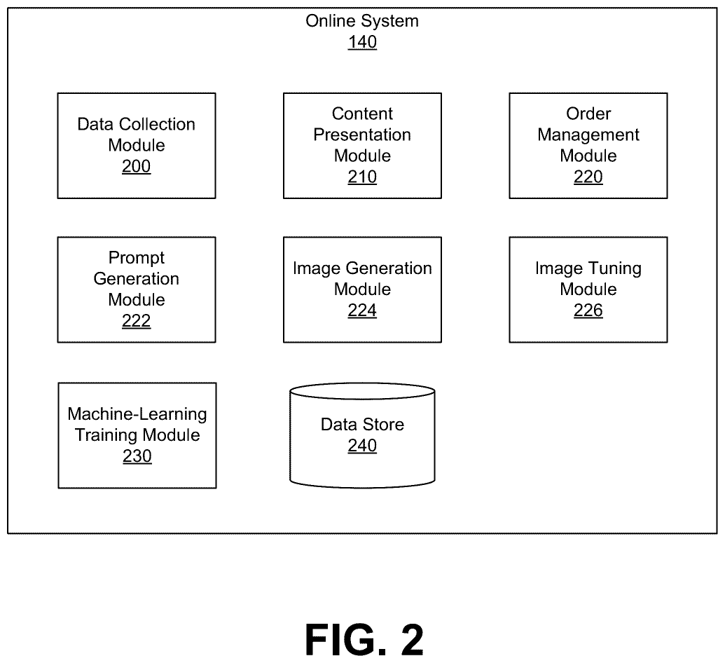

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform one or more tasks using machine-learned models. The tasks include, but are not limited to, natural language processing (NLP) tasks, audio processing tasks, image processing tasks, video processing tasks, and the like. In some embodiments, the machine-learned models deployed by the model serving system 150 are models configured to perform one or more NLP tasks. The NLP tasks include, but are not limited to, text generation, query processing, machine translation, chatbot applications, and the like. In some embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In some embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various tasks and synthesize and formulate output responses based on information extracted from the training data.

In some embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In some embodiments, the task for the model serving system 150 can primarily be based on reasoning and summarization of knowledge specific to the online system 140, rather than relying on general knowledge encoded in the weights of the machine-learned model of the model serving system 150. Thus, one type of the task may be to perform various types of queries on large amounts of data in an external corpus in conjunction with the machine-learned model of the model serving system 150. For example, the task may be to perform question-answering, text summarization, text generation, and the like based on information contained in the external corpus.

Thus, in some embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In some embodiments, the online system 140 performs a task in conjunction with the model serving system 150 and/or the interface system 160 to generate an image for item recommendations and/or other types of sponsored activity (e.g., advertisement) with a theme. In one implementation, the online system 140 generates a prompt for input to the model serving system 150. The prompt may include contextual information related to target customer users and a request to generate a theme for product recommendations and sponsored activities. For example, the contextual information may include geo-locations, time of the year, culture events, holidays, etc. In another implementation, the online system 140 may generate the theme by a computing platform of the online system 140, and the computing platform may include a model serving system that deploys machine-learned models. In one example, the online system 140 may access knowledge graphs to obtain additional information to formulate the prompt. The knowledge graph connects various entities within the online system 140 and represents relationships between those entities. For example, based on the knowledge graph, the online system 140 may identify top selling categories related to a particular theme. The prompt to a first machine-learned model deployed by the model serving system 150 may include the contextual information as well as the knowledge entity graph. The online system 140 receives a response to the prompt from the model serving system 150 based on execution of the machine-learned model using the prompt. The response includes the requested theme for item recommendations and/or advertisements.

In some embodiments, the online system 140 generates a subsequent prompt for input to the model serving system 150. The subsequent prompt may include at least the theme in the response and a request to generate a prompt for input to a machine-learned image generation model. The prompt to the image generation model includes at least a request to generate one or more images of one or more product items associated with the theme. The online system 140 receives a response to the subsequent prompt from the model serving system 150 based on execution of the machine-learned model using the subsequent prompt. The online system 140 obtains the prompt to the image generation model in the response. In some embodiments, the generated prompt may include detailed description of the desired images for recommendation of items and/or sponsored content items (e.g., advertisements). In some embodiments, the prompt may be generated by the online system 140 which includes the model serving systems.

In some embodiments, the model serving system 150 deploys a second machine-learned model (same or different as the first machine-learned model) which is an image or video generation model that receives a prompt (e.g., text, image, video) and generate one or more images and/or videos based on the prompt. In one implementation, the online system 140 provides the generated prompt to the model serving system 150 for execution by the image generation model. The online system 140 receives one or more images generated by executing the image generation model. The generated images are related to item recommendations and/or advertisements. The online system 140 presents at least one of the generated images to the target customer users, for example, in a storefront banner. In another embodiment, the second machine-learned model may be deployed on another model serving system different from the model serving system 150.

In some embodiments, the online system 140 further performs a task in conjunction with the model serving system 150 to automatically tune the image generation model with branded product images. The online system 140 may formulate a request to tune the image generation model by describing one or more branded items in different context settings. The online system 140 generates a finetuning training data set including one or more branded items, images of each branded item, and a class each respective branded item belongs to. Specifically, themes identified for item recommendations or advertisements may include branded items, or the online system 140 may want to promote branded items in the images. In such an instance, it is desirable for the images for promotion to include the particular item of the brand within various settings.

In some embodiments, for a particular item, the fine-tuned image generation model is configured to receive a text prompt that includes (i) a unique identifier for the branded item and (ii) the class for that item (“[vv] laundry detergent” where [vv] indicates particular laundry detergent brand from ABC Co.), and generate an image corresponding to the prompt. In some embodiments, the unique identifier is a token that represents the branded item and the LLM model may receive the token as an input. The image is generated with the particular image of the branded item corresponding to the unique identifier in a contextual setting that is described in the user prompt.

In some embodiments, the image generation model is fine-tuned by the model serving system 150 based on the fine-tuning training data set obtained by the online system 140 that includes various images of the particular branded item in various settings. A more detailed description of the fine-tuning process is provided in detail below in conjunction with the image tuning module 226.

The online system 140 provides a formulated prompt to the model serving system 150 for execution by the fine-tuned image generation model and receives one or more tuned images by executing the fine-tuned image generation model. In this way, the online system 140 may provide high quality, contextual relevant, and branded images for generating recommendations and/or subsequently sponsored content items (e.g., advertisements) to include in these recommendations to users of the online system 140.

Existing text-to-image generation models have shown progress in the creation of images based on textual descriptions. Despite these advancements, there are ongoing challenges in achieving precise control over specific elements within generated images. For example, the image generation model often lacks the ability of customization. The users may not be able to modify/customize the generated images according to specific needs and preferences. As such, the generated images often cannot capture the high fidelity of branded products, and the specific context of brand-agnostic recommendations.

The disclosure herein provides a method of using a fine-tuned image generation model that outputs high quality, contextually relevant, and branded images. The disclosed method may include a multi-step LLMs process, where a subsequent LLM uses an output from a precedent LLM as an input. For example, the disclosed method uses LLMs to generate a theme and text description in the theme. The generated text description is used as a prompt to the image generation model.

Additionally, the image generation model is fine-tuned with a fine-tuning training dataset. Unlike original models that are trained on large but finite datasets of text-image pairs, the fine-tuning training data include examples of specific or customized images of branded items. The image generation model becomes more adept at understanding and generating images contextually and specializes in recognizing and representing the specific characteristics and details of the branded items. Inputting images of branded items into the fine-tuned image generation model to generate themed images maintains brand consistency and adheres to the brand's visual identity. Moreover, generating images of branded items in various themes using a fine-tuned image model is cost-effective compared to traditional methods, which may involve photo shoots, graphic design, and post-production.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In some embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a prompt generation module 222, an image generation module 224, an image tuning module 226, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. For example, the data collection module 200 may collect customer data such as a customer's name, address, shopping preferences, favorite items, or stored payment instruments. In another example, the data collection module 200 may collect customer data including default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. In some embodiments, the data collection module 200 may collect item data including item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In some embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. In some embodiments, the content presentation module 210 may receive a search query that is free text for a word or set of words indicating items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

In some embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offers an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offers an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The prompt generation module 222 generates a prompt for input to an image generation model to generate images for generating recommendations and/or sponsored content items (e.g., advertisements). In some embodiments, the prompt generation module 222 constructs a prompt including a task request to the LLM to generate a theme for product recommendations and sponsored activities. The prompt may include contextual information related to target customers. In one implementation, the contextual information may include geo-locations, time of the year, culture events, holidays, etc. The online system 140 receives the response from the LLM (e.g., via model serving system 150) which includes the requested theme. In one example, the themes may vary by geographies, e.g., the U.S. Thanksgiving vs. Canada Thanksgiving. In another example, the themes may vary depending on the time of the year, e.g., spring cleaning essentials, winter essentials. In yet another example, the themes may be related to culture moments, e.g., viral cooking hacks, football games, etc. An example prompt to the LLM of the model serving system 150 may be:
“Given the [geo-context information], what theme can grocery shoppers be stocking up for?”
   The online system 140 may receive a response from the LLM that may be:
“The theme is spring cleaning.”

In one implementation, the prompt generation module 222 may access the knowledge graph and use information stored in the knowledge graph to formulate the input to the LLM. For example, the knowledge graph may provide information about items that are high sellers based on geo-context and time information. The prompt generation module 222 may add this information to the input to the LLM to request a theme that relates to this information, e.g., the high selling products. An example prompt to the LLM of the model serving system 150 may be:
“Given the geo-context information and knowledge graph data, what is the best top selling events for each category?”

The prompt generation module 222 receives the theme in the response from LLM and constructs a subsequent prompt including a task request to the LLM. The subsequent prompt includes at least the theme. The prompt generation module 222 may input the theme to the LLM and request the LLM to generate a prompt to feed to an image generation model. In some embodiments, the prompt generation module 222 requests the LLM to generate a prompt that includes a detailed request for the image generation model to generate images, e.g., generating one or more images of one or more product items associated with the theme. For instance, the generated prompt may include detailed description of the desired potential images for product recommendations and sponsored activities. An example prompt to the LLM of the model serving system 150 may be:
“Your task is to recommend the best possible prompt that can help generate a very polished image using diffusion model image generation model for the following scenario. Imagine you have to show a big display image on top of the home page of a grocery app.
Scenario: “show me a very polished image that captures sick day essentials. The image generated should be of very high quality.”

The online system 140 may receive a response, e.g., the generated prompt to an image model, from the LLM that may be:
“Generate a very high-quality image of sick day essentials displayed on a clean and organized countertop. The countertop should be made of a light-colored stone material with minimal veining. The essentials should include a box of tissues, a mug of hot tea with steam rising from it, a bowl of chicken noodle soup with steam rising from it, a small vase of fresh flowers, a bottle of cough syrup, a thermometer, and a cozy blanket draped over the countertop. The lighting should be warm and soft, with shadows cast in all the right places to make the image feel realistic and inviting. The final image should be in landscape orientation and have a resolution of 1920×1080 pixels.”

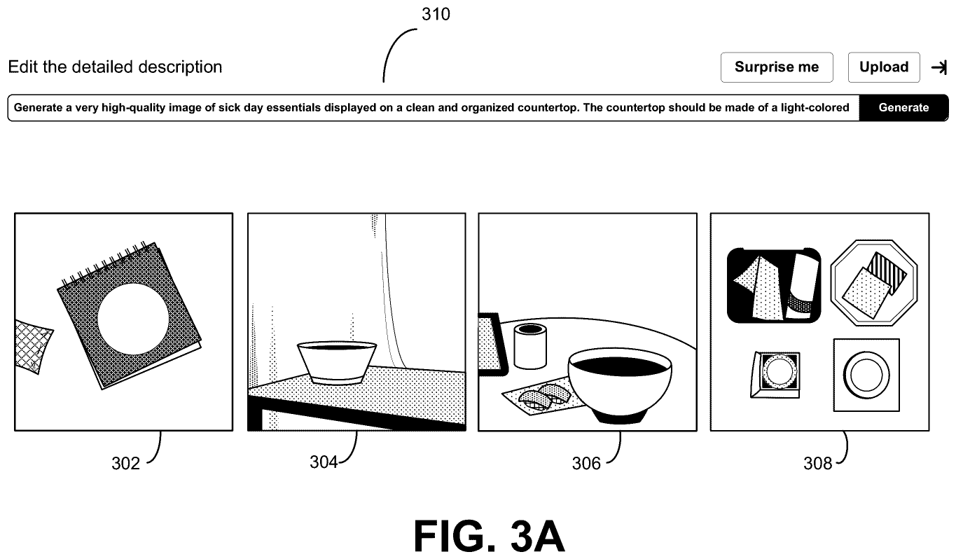

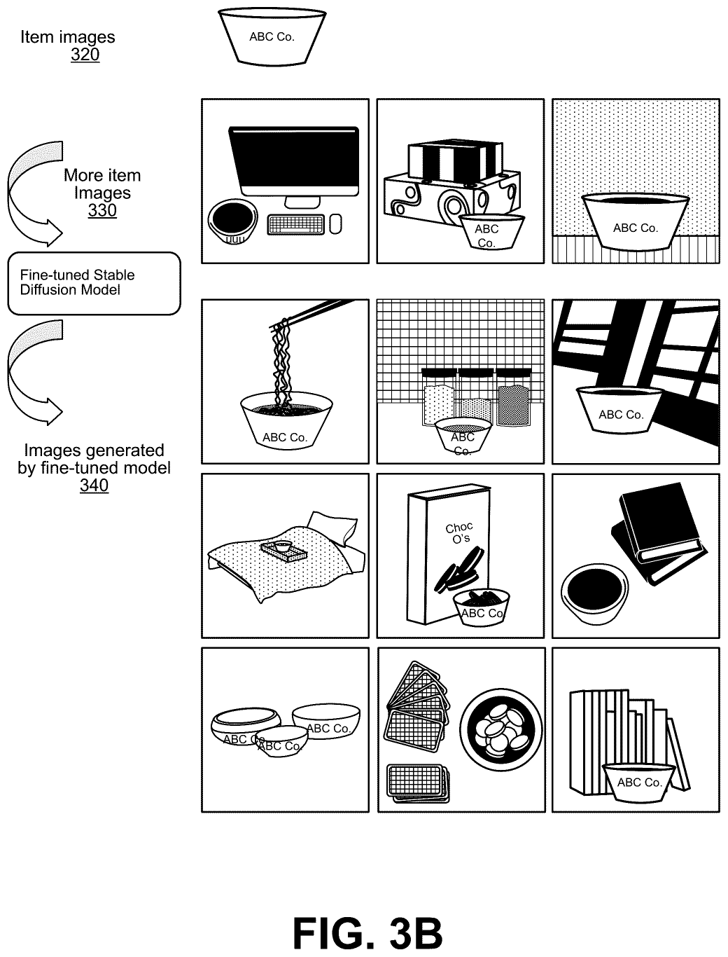

The image generation module 224 receives the generated prompt from the prompt generation module 222 and generates one or more images. FIG. 3A shows an example of generated images by the image generation module 222 using the generated prompt from the prompt generation module 222, in accordance with one or more embodiments. In some embodiments, the image generation module 224 provides the generated prompt for input to an image generation model (e.g., via the model serving system 150 or another system). In one example, the image generation model 224 may include a text-to-image generation model.

As shown in FIG. 3A, the image generation module 224 receives one or more images (e.g., 302, 304, 306, and 308) generated from the image generation model. The generated images are associated with the determined theme for generating product recommendations and sponsored activities. While the generated images meet the request included in the prompt, the generated images may illustrate items in various different set-ups, e.g., formats, shapes, angles, perspectives, arrangements, combinations, etc. In some embodiments, the images are brand agnostic. In some embodiments, the images include top selling products based on the knowledge graph data. In one instance, the image generation model is a diffusion-based model such as a latent diffusion model. In some implementations, the image generation module 224 may provide a user interface 310 for receiving/display the prompt input to the 224. The user interface 310 may be auto-filled by the prompt generated from the prompt generation module 222 and display it to the user for review. The user interface may be editable, a user may edit the generated prompt, such as, add, remove, or modify the request included in the prompt, e.g., changing “light-colored” to “neutral-colored.” In this way, the image generation module 224 may allow a user to manually customize the generated images.

As described above, the image tuning module 226 may further tune the parameters of the image generation model to generate images with a particular item (e.g., branded item content) given a class of items. The image tuning module 226 may coordinate fine-tuning of the image generation model. In some embodiments, the image tuning module 226 may finetune the images by including images of a particular item or a given brand, logo, shape of the item, and the like.

The image tuning module 226 prepares a fine-tuning data set that includes images of branded items, the class name of the branded items, and a unique identifier for each branded item from data available to the online system 140 or from retailers. The images of the branded items may include information that describes/identifies the branded product, such as, logo, shape of product, packaging, etc. For a particular item corresponding to a unique identifier, there may be 4-5 images of the item at different angles, perspectives, and the like. The image tuning module 226 provides the fine-tuning data set to the model serving system 150 so that the image generation model can be tuned as described with respect to FIG. 1A.

In some instances, the parameters of the image generation model are fine-tuned by propagating a prompt including the unique identifier and class of the item (e.g., “[vx] backpack”) and a noisy version of an image of the branded item into the image generation model to generate denoised outputs over one or more iterations (t=1, 2, . . . , T). For each iteration, the output is used to compute a reconstruction loss indicating a difference between tensors obtained from the known images and the denoised output.

In addition, an instance of the image generation model is fixed before the fine-tuning process. The prompt without the unique identifier (e.g., “backpack”) but with the class of the item is propagated into a fixed image generation model to generate a prior class image. The prompt and a noisy version of the prior class image is also propagated into the image generation model to generate denoised outputs over one or more iterations (t=1, 2, . . . , T). The outputs are used to compute a class-specific prior preservation loss indicating a similarity between the prior class image from the fixed image generation model and the output from the image generation model to be fine-tuned.

The loss function is a combination of the reconstruction loss and the class-specific prior preservation loss. In one or more instances, the loss function is given by:

$$E [ {w}_{t} ‖ \hat{{x}_{θ}} ( {α}_{t} x + {σ}_{t} ϵ , c ) - x {‖}_{2}^{2} + λ {w}_{t} ′ {‖ \hat{{x}_{θ}} ( {α}_{t} {′ x}_{pr} + {σ}_{t} {ϵ}^{′} , {c}_{pr} ) - {x}_{pr} ‖}_{2}^{2} ]$$

where x_{θ} denotes application of parameters θ of the image generation model, x denotes the image of a particular item (e.g., branded item), c is the fine-tuning prompt, xₚᵣ denotes the class image from the fixed image generation model, and cₚᵣ is a prompt including the class of the item. One or more terms are obtained from the loss function to update the parameters of the image generation model to reduce the loss function.

The image tuning module 226 receives the response from the fine-tuned image generation model, e.g., high quality, contextual relevant, and branded images, for product recommendations and sponsored activities. After the fine-tuning process, the fine-tuned image generation model is configured to receive a text prompt that includes at least (i) the generated prompt that includes a text-to-image generation task (e.g., the image generation prompt described with respect to FIG. 3A), (ii) a unique identifier for the branded item, and (iii) the class for that item (“[yx] backpack” where [yx] indicates backpack of a brand of Bags Inc.) and generate an image corresponding to the prompt.

FIG. 3B shows an example of finetuned images generated by the image tuning module 226, in accordance with one or more embodiments. In one example, after fine-tuning, the image generation module 224 may provide a prompt to the image generation model that may be:
“Generate a very high-quality image of sick day essentials displayed on a clean and organized countertop. The essentials should include a box of tissues, a mug of hot tea with steam rising from it, a bowl of [uuu] chicken noodle soup with steam rising from it, a small vase of fresh flowers, a bottle of cough syrup, a thermometer, and a cozy blanket draped over the countertop.”
   Where “a bowl of [uuu] chicken noodle soup” represents a particular brand of chicken noodle soup.

The fine-tuning prompt includes (i) the generated prompt that includes a text-to-image generation task, (ii) a unique identifier for the branded item, and/or (iii) the class for that item (“[uuu] chicken noodle soup” where [uuu] indicates chicken noodle soup of a particular brand). The unique identifier for the branded item and/or the class for that item may be used by the fine-tuned image generation model to generate images addressing the request in the prompt but that include high-fidelity images of the items.

The known images of branded items may be a generic/standard product image 320, and/or a plurality of product images 330 in different context settings, such as pictures taken from different angles, formats, scenes, etc. The multi-modal image generation model may be fine-tuned using images 320 and 330. The multi-modal LLM receives the fine-tuning prompt to generate various fine-tuned images 340. Each generated image includes at least the particular branded product requested in the prompt, e.g., [uuu] chicken noodle soup. The image tuning module 226 may output a set of fine-tuned images 340 and the user may select one or more from the set of fine-tuned images 340 for display. In this manner, the online system 140 is able to promote particular items in the recommendation images in an automated manner.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

In some embodiments, the data store 240 stores a knowledge graph that connects various entities within the online system 140 and represents relationships between those entities. In some embodiments, the entities are segments of users, items, item brands, item categories, tasks (e.g., preparing for birthday party) performed by users, and the like. The knowledge graph may include a set of nodes that each represent a respective entity. A node connected to another node in the knowledge graph represents a relationship between the respective entities. In one instance, a node at a first level of the knowledge graph represents a particular segment of users (e.g., users who are parents with children, users who are above a threshold age), children nodes at a second level connected to a respective parent node are one or more common tasks identified for the segment of users, and children nodes at a third level connected to a respective parent node are one or more item categories or item brands that the segment of users use to satisfy a respective task.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

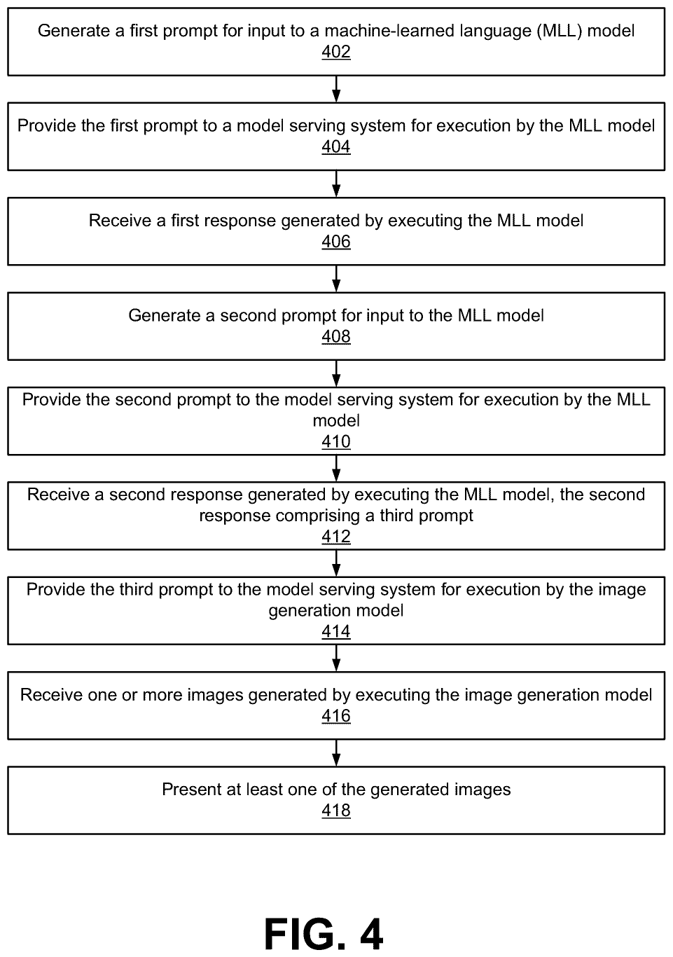

FIG. 4 is a flowchart for a method of generating images for product item, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system 140 generates 402 a prompt for input to a machine-learned language model. The prompt specifies at least contextual information and a first request to generate a theme for item recommendation. The online system 140 provides 404 the prompt to a model serving system for execution by the machine-learned language model and receives 406 from the model serving system, a response generated by executing the machine-learned language model on the prompt. The online system 140 generates 408 a subsequent prompt for input to the machine-learned language model. The subsequent prompt specifies at least the theme included in the response and a request to generate a prompt for input to an image generation model. The prompt to the image generation model includes a request to generate one or more images of one or more items associated with the theme. The online system 140 provides 410 the subsequent prompt to the model serving system for execution by the machine-learning language model and receives 412 a response generated by executing the machine-learning language model on the prompt. The response includes the requested prompt to feed to the image generation model. The online system 140 provides 414 the generated prompt to the model serving system for execution by the image generation model and receives 416 one or more images generated by executing the image generation model on the third prompt. The online system 140 presents 418 at least one of the generated images.

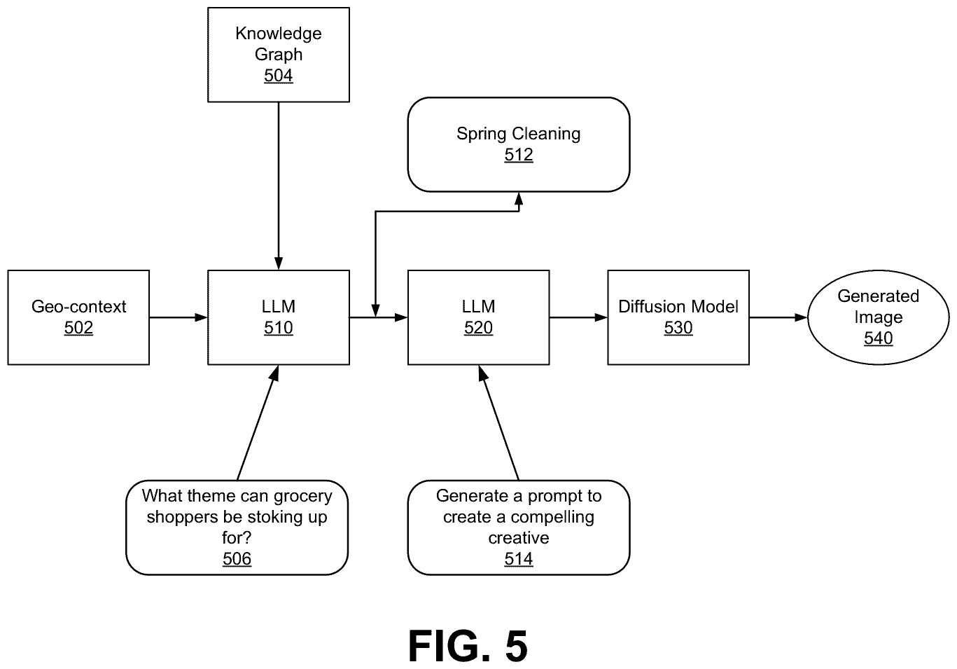

FIG. 5 is a flowchart illustrating an example method of generating images for product item recommendation, in accordance with some embodiments. As shown in FIG. 5, the online system 140 provides 510 a prompt for input to a large language model (LLM) to generate a theme for product recommendations. The prompt may include geo-context information 502, knowledge graph data 504 and a request task. In one example, the prompt 506 may be “what theme can grocery shoppers be stocking up for?” The LLM may generate a response comprising the requested theme 512, e.g., “spring cleaning.” The online system 140 provides 520 a subsequent prompt for input to the LLM to generate a prompt to image generation model. The subsequent prompt may include the theme 512. The online system 140 receives the response form the LLM, and the response includes the requested prompt. The received prompt may include detailed description of the desired images for product recommendations and sponsored activities. In some embodiments, the prompt may be a fine-tuning prompt 514 to create images of one or more branded items. The online system 140 provides 530 the generated prompt for input to the image generation model. In some embodiments, the image generation model may be diffusion model. The online system 140 receives 540 one or more images generated by executing the image generation model. The generated images may be related to product recommendations and sponsored activities. The online system 140 presents at least one of the generated images to the target customers, for example, in a storefront banner.

In some embodiments, the image generation model is fine-tuned with a fine-tuning data set which includes images of branded items, class name of the branded items, and/or a unique identifier for each branded item. The fine-tuning data set may be used to fine-tune parameters of the multi-modal LLM image generation model so that when prompted with the appropriate unique identifier, the model generates images addressing a prompt task but with the specific items that were mapped to that unique identifier during the fine-tuning process.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
generating a first prompt for input to a machine-learned language model, the first prompt specifying at least contextual information of a user and a first request to generate a theme for item recommendations for the user;
providing the first prompt to one or more model serving systems for execution by the machine-learned language model;
receiving, from the one or more model serving systems, a first response generated by executing the machine-learned language model on the first prompt, the first response comprising at least the requested theme;
generating a second prompt for input to the machine-learned language model or another machine-learned language model, the second prompt specifying at least the theme included in the first response and a second request to generate a third prompt for input to an image generation model, the third prompt comprising a third request to generate one or more images of one or more items associated with the theme;
providing the second prompt to the one or more model serving systems for execution by the machine-learned language model;
receiving, from the one or more model serving systems, a second response generated by executing the machine-learned language model on the second prompt, the second response comprising the requested third prompt;
providing the third prompt to the one or more model serving systems for execution by the image generation model;
receiving, from the one or more model serving systems, one or more images generated by executing the image generation model on the third prompt; and
presenting a recommendation to the user, the recommendation including at least one of the generated images.

2. The method of claim 1, further comprising:
obtaining a fine-tuning data set including images of one or more items in different settings for promoting the one or more items, a class name for each item, and a unique identifier representing each item; and
providing the fine-tuning data set to the one or more model serving systems for fine-tuning the image generation model.

3. The method of claim 2, wherein fine-tuning the image generation model comprises:
fixing one or more parameters of the image generation model;
applying the image generation model to a fine-tuning prompt and a noisy version of an image of a particular item to output denoised images of the particular item, the fine-tuning prompt including a unique identifier for the item and a class of the item;
applying the fixed parameters of the image generation model to a class-specific prompt to output an image of the class, the class-specific prompt including a class of the item;
applying the image generation model to the class-specific prompt and a noisy version of the image of the class to output denoised images of the class;
generating a reconstruction loss that indicates a difference between known images of the particular item and the denoised output images of the particular item; and
generating a class-specific prior preservation loss that indicates a difference between the image of the class and the denoised output images of the class; and
backpropagating terms obtained from the reconstruction loss and the class-specific prior preservation loss to update parameters of the image generation model.

4. The method of claim 2, wherein obtaining the images of a particular item in the one or more items comprises obtaining images of the particular item at different angles, perspectives, or arrangements.

5. The method of claim 1, wherein the third prompt further comprises a unique identifier for a particular item and a class for the particular item, and wherein the one or more generated images include the particular item.

6. The method of claim 1, wherein inputting the third prompt into the image generation model comprises inputting the third prompt into a diffusion-based model.

7. The method of claim 1, further comprising:
receiving, via a user interface, a user input for modifying the third prompt; and
providing the modified third prompt to the one or more model serving systems for execution by the image generation model.

8. The method of claim 7, further comprising:
updating the machine-learned language model using the user input as feedback.

9. The method of claim 1, wherein the second prompt and the third prompt are generated by a computing platform which includes the one or more model serving systems.

10. A computer program product comprising a non-transitory computer readable storage medium having instructions encoded thereon that, when executed by a processor, cause the processor to perform steps comprising:
generating a first prompt for input to a machine-learned language model, the first prompt specifying at least contextual information of a user and a first request to generate a theme for item recommendations for the user;
providing the first prompt to one or more model serving systems for execution by the machine-learned language model;
receiving, from the one or more model serving systems, a first response generated by executing the machine-learned language model on the first prompt, the first response comprising at least the requested theme;
generating a second prompt for input to the machine-learned language model or another machine-learned language model, the second prompt specifying at least the theme included in the first response and a second request to generate a third prompt for input to an image generation model, the third prompt comprising a third request to generate one or more images of one or more items associated with the theme;
providing the second prompt to the one or more model serving systems for execution by the machine-learned language model;
receiving, from the one or more model serving systems, a second response generated by executing the machine-learned language model on the second prompt, the second response comprising the requested third prompt;
providing the third prompt to the one or more model serving systems for execution by the image generation model;
receiving, from the one or more model serving systems, one or more images generated by executing the image generation model on the third prompt; and
presenting a recommendation to the user, the recommendation including at least one of the generated images.

11. The computer program product of claim 10, wherein the instructions, when executed by the processor, cause the processor to perform steps further comprising:
obtaining a fine-tuning data set including images of one or more items in different settings for promoting the one or more items, a class name for each item, and a unique identifier representing each item; and
providing the fine-tuning data set to the one or more model serving systems for fine-tuning the image generation model.

12. The computer program product of claim 11, wherein fine-tuning the image generation model comprises:
fixing one or more parameters of the image generation model;
applying the image generation model to a fine-tuning prompt and a noisy version of an image of a particular item to output denoised images of the particular item, the fine-tuning prompt including a unique identifier for the item and a class of the item;
applying the fixed parameters of the image generation model to a class-specific prompt to output an image of the class, the class-specific prompt including a class of the item; applying the image generation model to the class-specific prompt and a noisy version of the image of the class to output denoised images of the class;
generating a reconstruction loss that indicates a difference between known images of the particular item and the denoised output images of the particular item; and
generating a class-specific prior preservation loss that indicates a difference between the image of the class and the denoised output images of the class; and
backpropagating terms obtained from the reconstruction loss and the class-specific prior preservation loss to update parameters of the image generation model.

13. The computer program product of claim 11, wherein obtaining the images of a particular item in the one or more items comprises obtaining images of the particular item at different angles, perspectives, or arrangements.

14. The computer program product of claim 10, wherein the third prompt further comprises a unique identifier for a particular item and a class for the particular item, and wherein the one or more generated images include the particular item.

15. The computer program product of claim 10, wherein inputting the third prompt into the image generation model comprises inputting the third prompt into a diffusion-based model.

16. The computer program product of claim 10, wherein the instructions, when executed by the processor, cause the processor to perform steps further comprising:
receiving, via a user interface, a user input for modifying the third prompt; and
providing the modified third prompt to the one or more model serving systems for execution by the image generation model.

17. The computer program product of claim 16, wherein the instructions, when executed by the processor, cause the processor to perform steps further comprising:
updating the machine-learned language model using the user input as feedback.

18. The computer program product of claim 10, wherein the second prompt and the third prompt are generated by a computing platform which includes the one or more model serving systems.

19. A computer system comprising:
a processor; and
a non-transitory computer-readable storage medium having instructions that, when executed by the processor, cause the computer system to perform steps comprising:
generating a first prompt for input to a machine-learned language model, the first prompt specifying at least contextual information of a user and a first request to generate a theme for item recommendations for the user;
providing the first prompt to one or more model serving systems for execution by the machine-learned language model;
receiving, from the one or more model serving systems, a first response generated by executing the machine-learned language model on the first prompt, the first response comprising at least the requested theme;
generating a second prompt for input to the machine-learned language model or another machine-learned language model, the second prompt specifying at least the theme included in the first response and a second request to generate a third prompt for input to an image generation model, the third prompt comprising a third request to generate one or more images of one or more items associated with the theme;
providing the second prompt to the one or more model serving systems for execution by the machine-learned language model;
receiving, from the one or more model serving systems, a second response generated by executing the machine-learned language model on the second prompt, the second response comprising the requested third prompt;
providing the third prompt to the one or more model serving systems for execution by the image generation model;
receiving, from the one or more model serving systems, one or more images generated by executing the image generation model on the third prompt; and
presenting a recommendation to the user, the recommendation including at least one of the generated images.

20. The system of claim 19, wherein the instructions, when executed by the processor, cause the computer system to perform steps further comprising:
obtaining a fine-tuning data set including images of one or more items in different settings for promoting the one or more items, a class name for each item, and a unique identifier representing each item; and
providing the fine-tuning data set to the one or more model serving systems for fine-tuning the image generation model.

21. The system of claim 20, wherein fine-tuning the image generation model comprises:
fixing one or more parameters of the image generation model;
applying the image generation model to a fine-tuning prompt and a noisy version of an image of a particular item to output denoised images of the particular item, the fine-tuning prompt including a unique identifier for the item and a class of the item;
applying the fixed parameters of the image generation model to a class-specific prompt to output an image of the class, the class-specific prompt including a class of the item; applying the image generation model to the class-specific prompt and a noisy version of the image of the class to output denoised images of the class;
generating a reconstruction loss that indicates a difference between known images of the particular item and the denoised output images of the particular item; and
generating a class-specific prior preservation loss that indicates a difference between the image of the class and the denoised output images of the class; and
backpropagating terms obtained from the reconstruction loss and the class-specific prior preservation loss to update parameters of the image generation model.

22. The system of claim 20, wherein obtaining the images of a particular item in the one or more items comprises obtaining the images of the particular item at different angles, perspectives, or arrangements.

23. The system of claim 19, wherein the third prompt further comprises a unique identifier for a particular item and a class for the particular item, and wherein the one or more generated images include the particular item.

24. The system of claim 19, wherein the instructions, when executed by the processor, cause the computer system to perform steps further comprising:
receiving, via a user interface, a user input for modifying the third prompt; and
providing the modified third prompt to the one or more model serving systems for execution by the image generation model.
